(19) United States
(12) Patent Application Publication
(10) Pub. No.: US 2026/0039198 A1
(43) Pub. Date: Feb. 5, 2026

(54) INTEGRATION-BASED CURRENT EMULATION FOR A POWER CONVERTER

(71) Applicant: TEXAS INSTRUMENTS INCORPORATED, Dallas, TX (US)

(72) Inventors: Preetam Tadeparthy, Bangalore (IN); Dattatreya Baragur Suryanarayana, Bangalore (IN); Evan Reutzel, Center Valley, PA (US); VishnuVardhan Reddy J, Bangalore (IN); Bikash Pradhan, Bangalore (IN)

(21) Appl. No.: 18/789,334

(22) Filed: Jul. 30, 2024

(51) Int. Cl. H02M 3/158; H02M 1/00; H02M 1/14; H02M 3/157

(52) U.S. Cl. CPC H02M 3/158; H02M 1/0009; H02M 1/14; H02M 3/157

(57) ABSTRACT

An apparatus includes a first switch having a terminal coupled to an input voltage terminal. The apparatus further includes a second switch coupled to the first switch at a switching terminal, a sense circuit coupled to the second switch and having an output, and a capacitor. An integrator has a first input coupled to the output of the sense circuit and has a second input coupled to the capacitor.

### BACKGROUND

A multiphase power converter includes multiple output power phases coupled in parallel. Each power phase may include a pair of transistors coupled to an inductor. A controller controls the timing of the transistors within the power phases. A transinductance voltage regulator (TLVR) is a multiphase power converter that includes a serially-connected set of “secondary” inductors. Each secondary inductor is magnetically coupled to a corresponding inductor (a “primary” inductor) of a power phase of the regulator. When a change in duty cycle occurs resulting from a load transient, the change in duty cycle is immediately reflected in each of the serially-connected set of secondary inductors. The current through the primary inductors of the power phases adjusts (increase or decrease) more rapidly due to the magnetically-coupled secondary inductors than would have been the case absent the secondary inductors.

### SUMMARY

In one example, an apparatus includes a first switch having a terminal coupled to an input voltage terminal and a second switch coupled to the first switch at a switching terminal. A sense circuit is coupled to the second switch and has an output. An integrator has a first input coupled to the output of the sense circuit and has a second input coupled to a capacitor.

In another example, an apparatus includes a capacitor having a terminal, a first current source circuit having an output coupled to the terminal of the capacitor, and a second current source circuit having an output coupled to the terminal of the capacitor. An integrator has a first input and has a second input. The second input is coupled to the terminal of the capacitor. The integrator is configured to integrate a difference between a signal at the first input and a voltage from the capacitor over a first time window and over a second time window. The second time window partially overlaps the first time window.

In yet another example, a power converter includes a controller having a first output, a second output, first input, and a second input. A first power stage circuit has an input coupled to the first output of the controller, a first output coupled to the first input of the controller, and has a second output. The first power stage circuit includes a first integrator configured to integrate a difference between a first signal and a second signal. A second power stage circuit has an input coupled to the second output of the controller, a first output coupled to the second input of the controller, and has a second output. The second power stage circuit includes a second integrator configured to integrate a difference between a third signal and a fourth signal. A first inductor has a first terminal coupled to the second output of the first power stage circuit and has a second terminal. A second inductor has a first terminal coupled to the second output of the second power stage circuit and has a second terminal coupled to the second terminal of the first inductor.

### BRIEF DESCRIPTION OF THE DRAWINGS

FIGS. 1A and 1B (collectively, FIG. 1) is a schematic diagram of a transimpedance voltage regulator (TLVR), in an example.

FIG. 2 is a graph of a current waveform through inductors of the TLVR, in an example.

FIG. 3 is a graph of an example waveform of an inductor's current of a TLVR in which a portion of the waveform is an emulated current signal and another portion of the waveform is a sensed current signal.

FIG. 4 is a schematic diagram of power stage coupled to an inductor and a capacitor for use in a TLVR application in an example.

FIG. 5 is a schematic diagram of power stage coupled to an inductor and a capacitor for use in the TLVR, in another example.

FIGS. 6A and 6B (collectively, FIG. 6) is a schematic diagram of an emulation circuit usable in the power stages of the TLVR of FIG. 1, in an example.

FIG. 7 is a graph of current through an inductor of a power stage illustrating the timing for integrating a difference between a sense current and emulation signal over multiple integration time windows, in an example.

FIG. 8 is a flow diagram illustrating the operation of the emulation circuit of FIG. 6, in an example.

FIG. 9 is a schematic diagram illustrating the generation of a voltage proportional to the output voltage based on the voltage at a switching terminal of the TLVR, in an example.

FIGS. 10A and 10B (collectively, FIG. 10) is a schematic diagram of an emulation circuit usable in the power stages of the TLVR of FIG. 1, in another example.

FIG. 11 is a schematic diagram of at least a portion of an operational amplifier for which the offset voltage can be adjusted, in an example.

### DETAILED DESCRIPTION

The same reference numbers or other reference designators are used in the drawings to designate the same or similar (either by function and/or structure) features.

For a multiphase power converter, it is desirable to sense or determine the current through the inductor of each phase. For example, determining the current through each phase helps to ensure the currents of the phases are properly balanced. Each phase has an “on-time” in which a high side (HS) transistor is on and an “off-time” in which a low side (LS) transistor is on. At low duty cycle operation, the on-time of the power converter may be too short to reliably sense the inductor current that flows through the HS transistor. Accordingly, many power converters provide low-side current sensing and not high-side current sensing. In low-side current sensing, the current through the LS transistor is sensed. To determine the inductor current during the on-time, a current emulation technique, described below, may be employed which is based on low-side current sensing. However, as explained below, determining the current through the HS transistor based on current sensed during the off-time of a phase of a TLVR can be difficult to achieve accurately. The examples described herein pertain to an integration-based technique for each phase to generate an emulated current signal corresponding to the low-side sensed current through the respective phase.

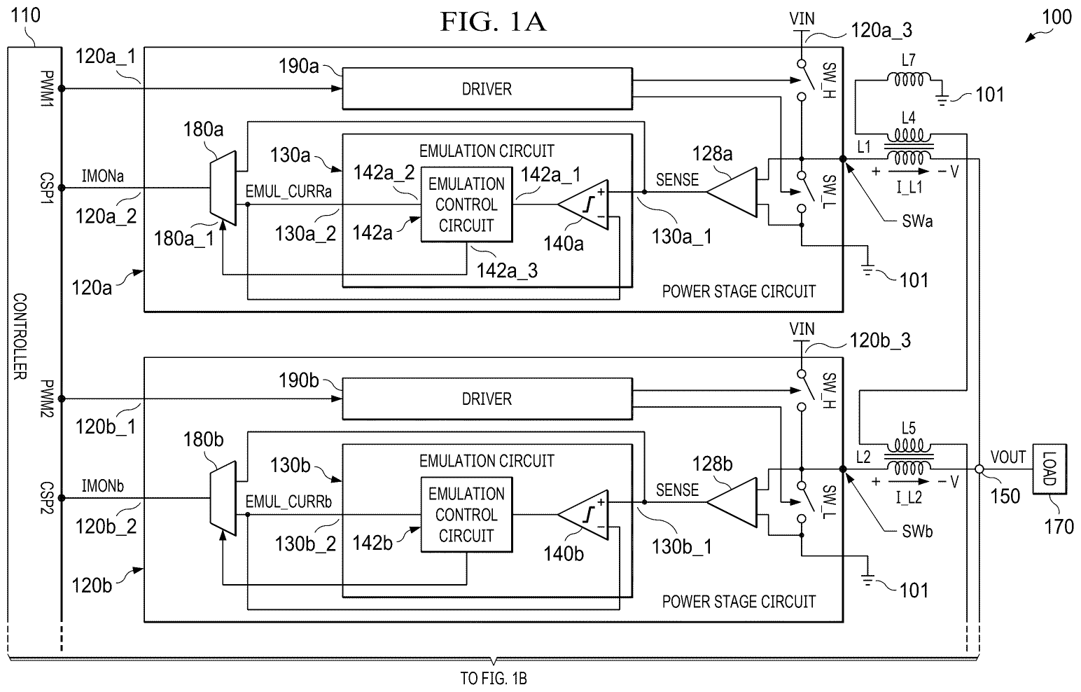

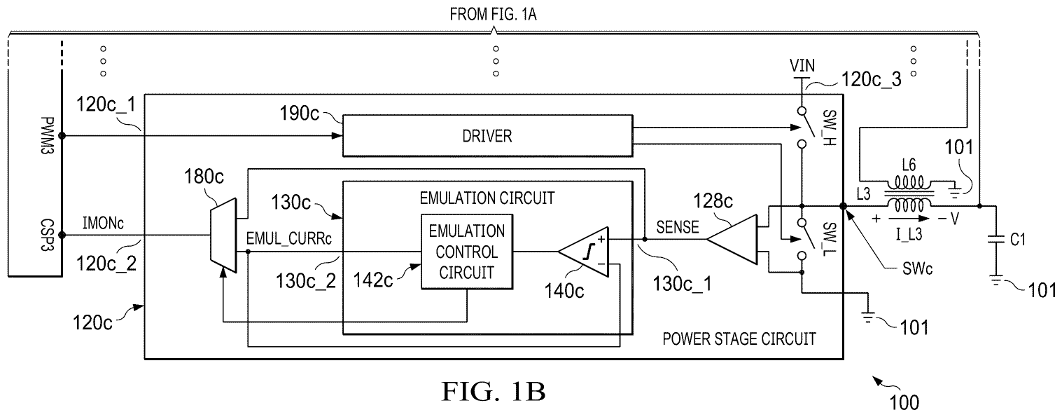

FIG. 1 is a schematic diagram of a TLVR 100 including a controller 110, power stage circuits 120a, 120b, and 120c, inductors L1, L2, L3, L4, L5, L6, and L7, and a capacitor C1. TLVR 100 converts an input voltage Vin into an output voltage Vout. Although three power stage circuits 120a-120c (collectively, power stage circuits 120) are shown in the example of FIG. 1, TLVR 100 may have any suitable number of power stage circuits. In one example, controller 110 is fabricated as an integrated circuit (IC), and power stage circuits 120 are fabricated as separate ICs. In another example, power stage circuits 120a-120c may be fabricated as a single IC. The components of TLVR 100 (e.g., the ICs containing controller 110 and power stage circuits 120) may be mounted on a circuit board (e.g., a printed circuit board (PCB)).

Controller 110 has a pulse width modulation (PWM) output and a current sense input for each power stage circuit 120. For example, controller 110 has a PWM output PWM1 and a current sense input CSP1 for power stage circuit 120a, a PWM output PWM2 and a current sense input CSP2 for power stage circuit 120b, and a PWM output PWM3 and a current sense input CSP3 for power stage circuit 120c.

Each power stage circuit 120 has a PWM input, a current sense output, an input voltage terminal, and a switching terminal. For example, power stage circuit 120a has a PWM input 120a_1, a current sense output 120a_2, an input voltage terminal 120a_3, and a switching terminal SWa. Power stage circuit 120b has a PWM input 120b_1, a current sense output 120b_2, an input voltage terminal 120b_3, and a switching terminal SWb. Power stage circuit 120c has a PWM input 120c_1, a current sense output 120c_2, an input voltage terminal 120c_3, and a switching terminal SWc. The controller's PWM output PWM1 is coupled to PWM input 120a_1, and current sense output 120a_2 is coupled to current sense input CSP1. PWM output PWM2 is coupled to PWM input 120b_1, and current sense output 120b_2 is coupled to current sense input CSP2. PWM output PWM3 is coupled to PWM input 120c_1, and current sense output 120c_2 is coupled to current sense input CSP3. One terminal of inductor L1 is coupled to switching terminal SWa, and another terminal of inductor L1 is coupled to an output voltage terminal 150. One terminal of inductor L2 is coupled to switching terminal SWb, and another terminal of inductor L2 is coupled to the output voltage terminal 150. One terminal of inductor L3 is coupled to switching terminal SWc, and another terminal of inductor L3 is coupled to the output voltage terminal 150. The currents through inductors L1, L2, and L3 are the respective currents I_L1, I_L2, and I_L3. Power stage circuits 120a, 120b, and 120c generate respective signals IMONa, IMONb, and IMONc at their current sense outputs 120a_2, 120b_2, and 120c_2. As described below, signals IMONa, IMONb, and IMONc represent the currents I_L1, I_L2, and I_L3 through inductors L1, L2, and L3.

Inductors L4-L7 are coupled in series between ground terminals 101. Inductors L4, L5, and L6 are inductively-coupled to their respective inductors L1, L2, and L3. Inductively-coupled means that a current in one inductor of the pair of inductively-coupled inductors induces a current in the other inductor of the pair. Each pair of inductors L1/L4, L2/L5 and L3/L6 forms a transformer. Inductors L1-L3 are referred to as “primary” inductors and inductors L4-L6 are referred to as “secondary” inductors. Inductor L7 is used to adjust the transient performance of the TLVR 100. In one example, transient performance is improved with lower values of the inductance of inductor L7.

The input voltage Vin is provided to the input voltage terminals 120a_3, 120b_3, and 120c_3 of the power stage circuits 120, and the output voltage Vout is generated at the output voltage terminal 150. The output voltage terminal 150 can be coupled to a load 170, and TLVR 100 can power the load. In one example, load 170 includes one or more electrical components of a computer (e.g., a server computer) such as one or more microprocessors, memory, interfaces, etc. In general, load 170 can be any type of electrical component or system using the output voltage Vout from TLVR 100 for its operation.

Each power stage circuit 120 includes a high side switch, a low side switch, a current sense circuit, an emulation circuit, a multiplexer (e.g., an analog multiplexer), and a driver. In some examples, each high side switch is a transistor (e.g., a field effect transistor) and each low side switch also is a transistor (e.g., a field effect transistor). Power stage circuit 120a has a high side switch SW_H, a low side switch SW_L, a current sense circuit 128a, an emulation circuit 130a, an analog multiplexer 180a, and a driver 190a. Power stage circuit 120b has a high side switch SW_H, a low side switch SW_L, a current sense circuit 128b, an emulation circuit 130b, an analog multiplexer 180b, and a driver 190b. Power stage circuit 120c has a high side switch SW_H, a low side switch SW_L, a current sense circuit 128c, an emulation circuit 130c, an analog multiplexer 180c, and a driver 190c. Emulation circuits 130a-130c are referred to herein as emulation circuits 130. Drivers 190a, 190b, and 190c have inputs that receive a respective PWM signal from controller 110 and have outputs coupled to control inputs (e.g., gates of FETs) of their respective high side and low side switches. Drivers 190a-190c turn on and off their respective high side and low side switches based on their respective PWM signals.

A terminal of the high side switch SW_H of power stage circuit 120a is coupled to the input voltage terminal 120a_3. Another terminal of the high side switch SW_H of power stage 120a is coupled to a terminal of the low side switch SW_L at the switching terminal SWa. Another terminal of the low side switch SW_L is coupled to the ground terminal 101. Current sense circuit 128a is coupled across the low side switch SW_L. In one example, current sense circuit 128a includes an amplifier that amplifies the voltage produced across the on-resistance of the low side switch SW_L. Other types of current sense circuits are possible as well such as a sense resistor (e.g., 20 milliohms) coupled in series with the low side switch SW_L and an amplifier to amplify the voltage difference across the sense resistor. Current sense circuit 128a provides a current sense signal SENSE based on the current through the low side switch SW_L.

Emulation circuit 130a includes an integrator 140a coupled to an emulation control circuit 142a. Integrator 140a includes a positive (+) input and a negative (−) input. The positive input of integrator 140a is coupled to the output of current sense circuit 128a. The output of integrator 140a is coupled to an input 142a_1 of emulation control circuit 142a, and an output 142a_2 of emulation control circuit 142a is coupled to the negative input of integrator 140a and to an output 130a_2 of emulation circuit 130a. Emulation circuit 130a generates a signal EMUL_CURRa at output 130a_2. The output of current sense circuit 128a is coupled to one input of analog multiplexer 180a, and the output 130a_2 of emulation circuit 130a is coupled to another input of analog multiplexer 180a. Emulation control circuit 142a has an output 142a_3 coupled to a selection input 180a_1 of analog multiplexer 180a. The output of analog multiplexer 180a is coupled to the current sense output 120a_2 of power stage circuit 120a.

Emulation circuit 130b has an integrator 140b coupled to an emulation control circuit 142b. Emulation circuit 130c has an integrator 140c coupled to an emulation control circuit 142c. Integrators 140a, 140b, and 140c are also referred to as integrators 140. Emulation circuits 130b and 130c, analog multiplexers 180b and 180c, and drivers 190b and 190c of power stage circuits 120b and 120c are configured the same or similar to that described above for power stage circuit 120a. Emulation circuits 130b and 130c generate signals EMUL_CURRb and EMUL_CURRc at their respective outputs 130b_2 and 130c-2.

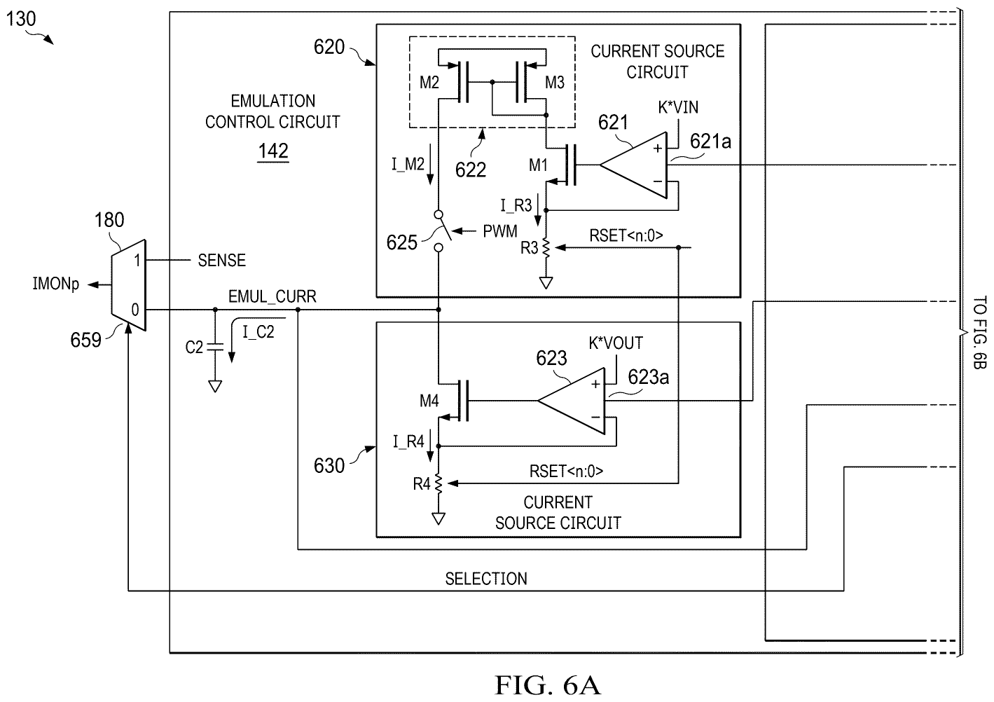

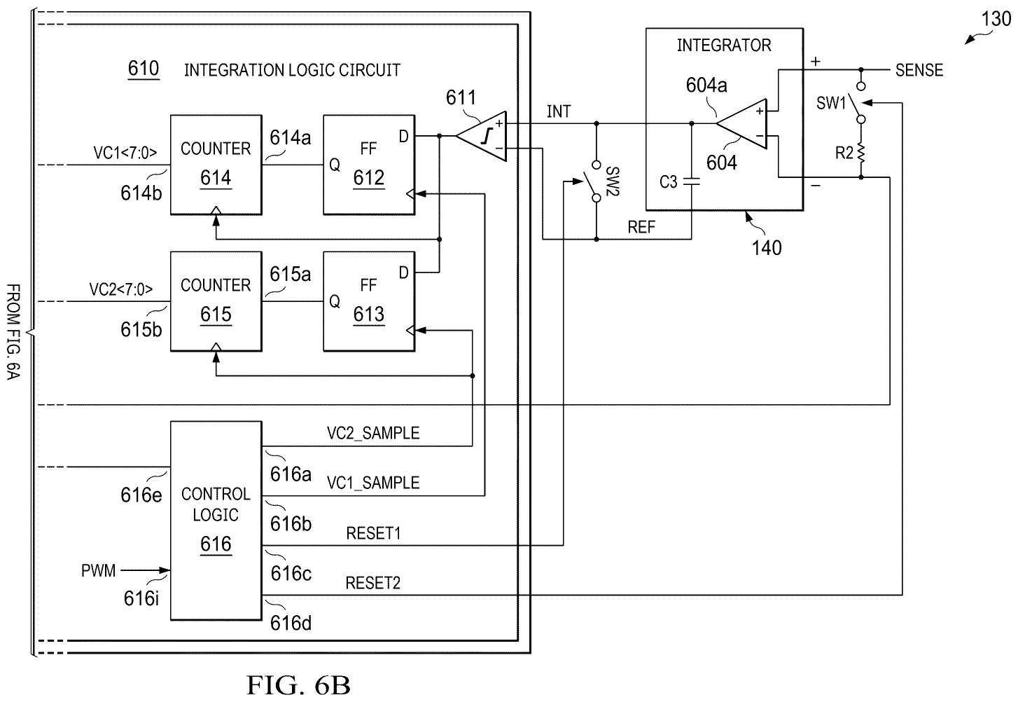

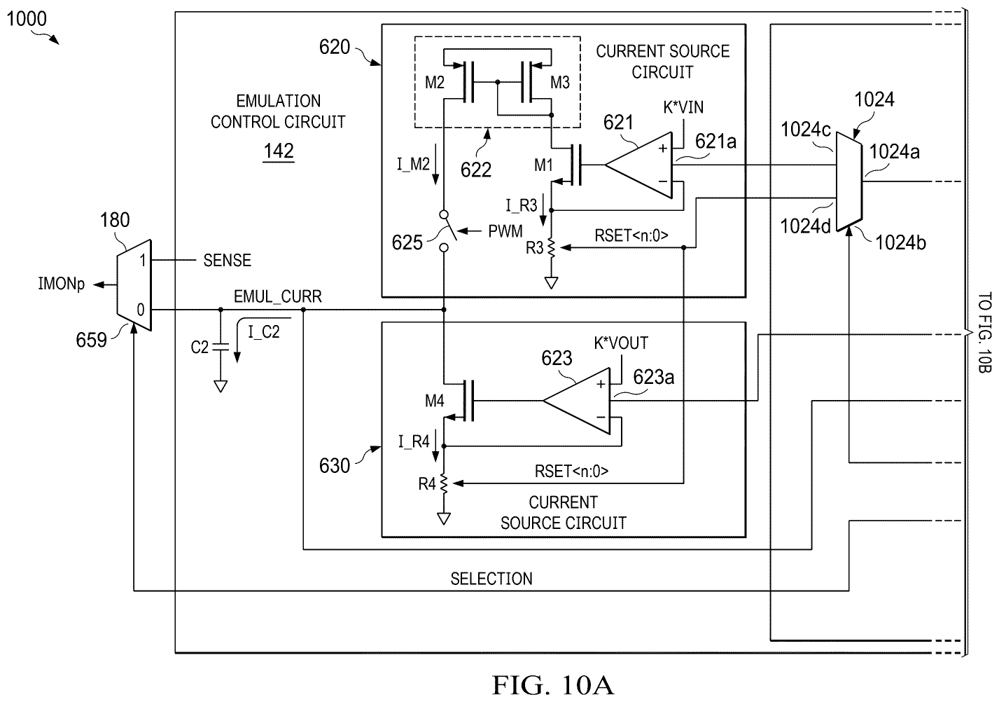

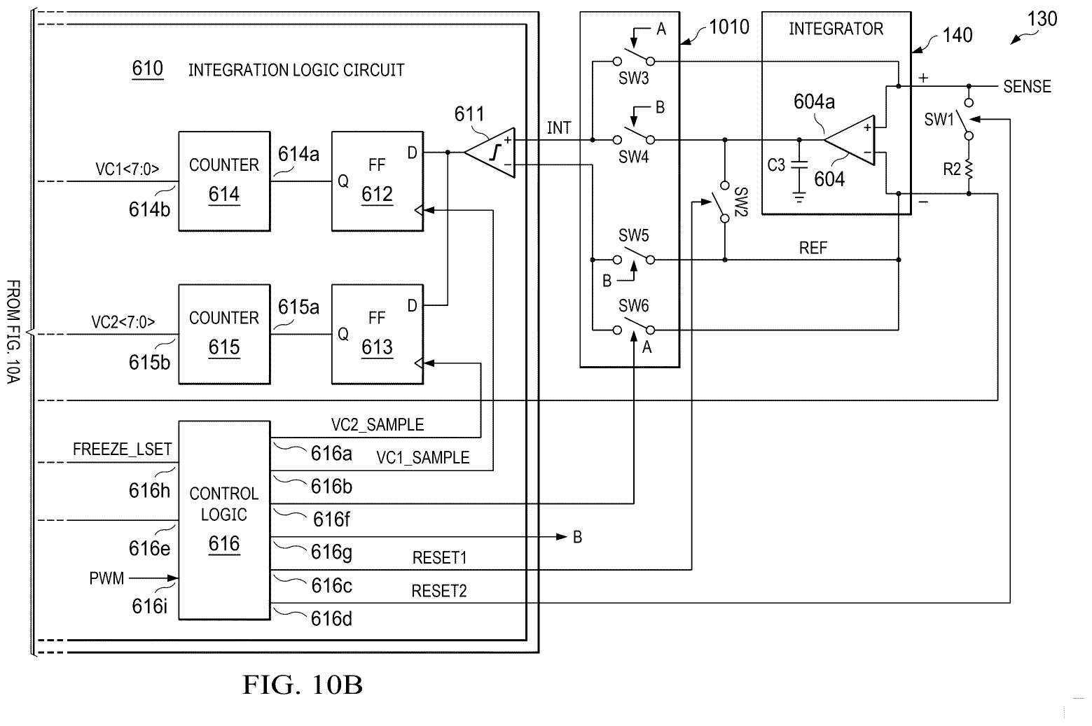

Each of emulation control circuits 142a, 142b, and 142c (collectively emulation control circuits 142) has a capacitor and voltage-controlled current sources, shown in FIGS. 6 and 10 and described below. Integrator 140 integrates the difference between the actual current information (e.g., current sense signal SENSE) obtained during an off-time (Toff) in which the LS switch is on and HS switch is off from the respective current sense circuit 128a, 128b, 128c (collectively, current sense circuits 128) and the respective emulation circuit's output signal IMONa, IMONb, and IMONc (collectively output signal IMON). Based on the output signal from integrator 140, emulation control circuit 142 adjusts the current produced by the voltage-controlled current sources to charge and discharge the capacitor at a rate that emulates the respective current I_L1, I_L2, and I_L3 through that power stage circuit's primary inductor (e.g., inductor L1, L2, and L3) during the on-time (SW_H is on) and blanking period (described below). The emulation control circuit 142a, 142b, and 142c of each emulation circuit 130a, 130b, and 130c controls the respective analog multiplexer 180a, 180b, and 180c to select the respective current sense signal SENSE to be provided as the respective output signal IMONa, IMONb, and IMONc during the on-time and blanking period. During the off-time (SW_L switch is on), the emulation control circuit 142a, 142b, and 142c of each emulation circuit 130a, 130b, and 130c controls the respective analog multiplexer 180a, 180b, and 180c to select the respective current sense signal SENSE to be provided as the respective signals IMONa, IMONb, and IMONc.

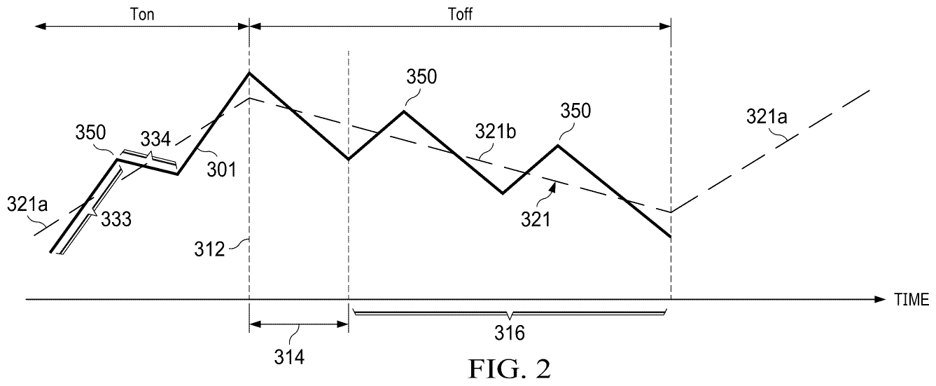

FIG. 2 is a graph illustrating an example waveform 301 of current I_L1 through primary inductor L1 of power stage circuit 120a. Waveform 321 represents the average of the current of waveform 301, which would be the current through primary inductor L1 absent the influence of the secondary inductors L4-L6. Absent inductors L4-L6, in response to high side switch SW_H turning on, the current of the primary inductor I_L1 ramps up as indicated by reference numeral 321a, and in response to low side switch SW_L turning on, current I_L1 ramps down as indicated by reference numeral 321b. Waveform 301 has the same general upward and downward progression as waveform 321 but has a ripple current superimposed on it due to current induced in the primary inductor L1 from current through its associated secondary inductor L4 which is generated by the other phases. During the on-time and off-time of the other power stage circuits 120b and 120c, the current increasing and decreasing in the respective primary inductors L2 and L3 of power stage circuits 120b and 120c induces current in closely-coupled secondary inductors L5 and L6, respectively. Because secondary inductors L4-L6 are coupled in series, any current induced in secondary inductor L5 or L6 also flows through secondary inductor L4 and induces a current in primary inductor L1. Waveform 301 represents the current through primary inductor L1 due to both the high side and low switches SW_H and SW_L of power stage circuit 120a being sequentially turned on and off and the current induced in primary inductor L1 from its closely-coupled secondary inductor L4 resulting from the on and off-times of power stage circuits 120b and 120c. The local peaks 350 coincide with the peak current of the other phases' primary inductors L2 and L3 and occur at different points in time because controller 110 staggers the on and off phases of the various power stage circuits. The current waveforms of the primary inductors L2 and L3 of power stage circuits 120b and 120c are similar to that shown in FIG. 2 for power stage circuit 120a.

The graph of FIG. 2 illustrates the on-time, Ton, and the off-time, Toff, of power stage circuit 120a. The off-time Toff begins at time point 312 when the high side switch SW_H turns off and the low side switch SW_L turns on. During a period 314 of the off-time, enough ringing may be present at the switching terminal SWa, SWb, SWc (collectively, switching terminal SW) that the current sense signal SENSE from current sense circuit 128 is not reliable. Period 314 may be referred to as a “blanking period” which is part of the off-time but for which current sensing is not performed. The next period of time 316, after the blanking period to the end of off-time Toff, is a time period during which current sense circuit 128 can be used to sense current of the respective power stage's primary inductor L1, L2, or L3 and use the sensed current, as described below, to emulate the primary inductor's current during the on-time Ton and blanking period 314.

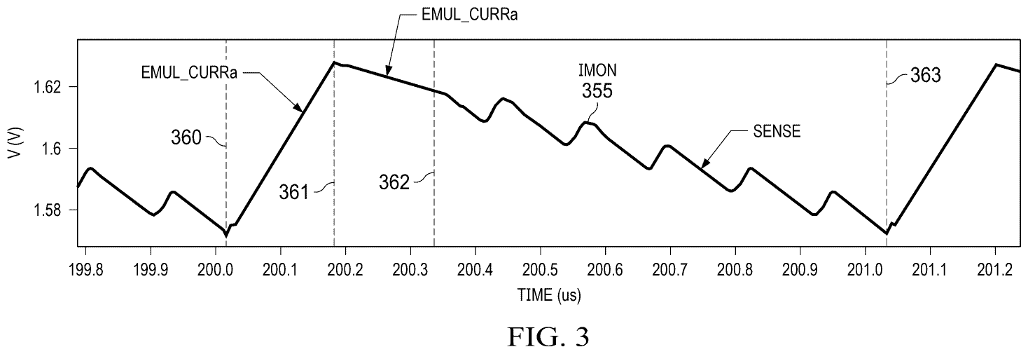

FIG. 3 is an example waveform 355 of signal IMON from emulation circuit 130. In an example, emulation control circuit 142 controls the state of analog multiplexer 180 to output signal EMUL_CURR as signal IMON during the on-time Ton, which starts at time point 360, and blanking period 314, which is between time points 361 and 362, and to output current sense signal SENSE starting at time point 362 and for the duration of the off-time until time point 363. Accordingly, during the off-time after the blanking period, waveform 355 includes the ripple current caused by the influence of the secondary inductors L4-L6 but such ripple current is not present in signal IMON during the on-time Ton and blanking period 314.

As described above, emulation circuits 130 charge and discharge a capacitor within the respective emulation control circuits 142a, 142b, and 142c. Accordingly, the voltage across the capacitor, which is the signal EMUL_CURR, increases and decreases approximately linearly. Integrator 140 is used to control the magnitude of the current produced by the current sources that charge and discharge the capacitor to so that the rate at which emulation signal EMUL_CURR increases and decreases approximately equals the rate at which the average of current I_L1, I_L2, and I_L3 of the primary inductors L1-L3 increases and decreases. The rate of change of current through an inductor

$$( \frac{di}{dt} )$$

is given by:

$$\frac{di}{dt} = \frac{V}{L} \qquad ( Eq . 1 )$$

where V is the voltage drop across the inductor (see voltage V in FIG. 1) and L is the inductance of the inductor. During the on-time of a given power stage circuit, the voltage drop across the corresponding primary inductor L1, L2, or L3 is Vin-Vout. Accordingly, the rate of change of current I_L1 (or I_L2, I_L3) during the on-time of, for example, power stage circuit 120 is:

$$\frac{di}{dt} = \frac{Vin - Vout}{L 1} \qquad ( Eq . 2 )$$

During the off-time of a given power stage circuit, the voltage drop across that power stage's primary inductor is −Vout. Accordingly, the rate of change of current I_L1 during the off-time of power stage circuit 120 is:

$$\frac{di}{dt} = \frac{- Vout}{L 1} \qquad ( Eq . 3 )$$

Emulation circuits 130 adjust the currents produced by the current sources so that the rate of change of voltage across that emulation circuit's capacitor approximates the rate of change of the average current through that power stage circuit's primary inductor. As described in the example below, the emulation circuit 130 for each power stage circuit generates its respective signal EMUL_CURR in this manner based on values representing Vin, Vout, and L, where L is the inductance of the respective primary inductor L1-L3.

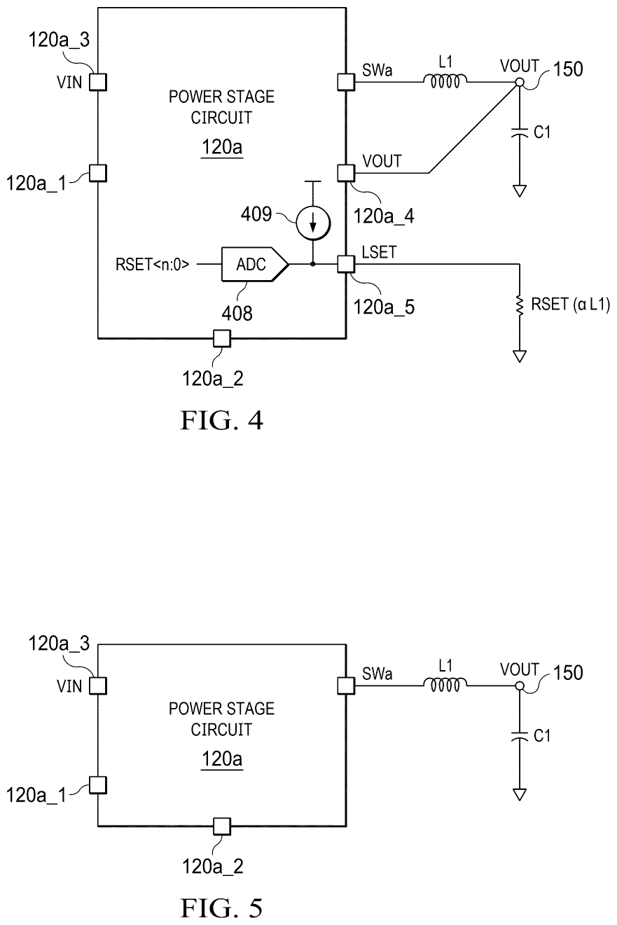

FIG. 4 is a schematic diagram of an example power stage circuit 120a coupled to inductor L1 and capacitor C1. The same schematic diagram applies to power stage circuits 120b and 120c as well. Power stage circuit 120a in this example has the PWM input 120a_1, current sense output 120a_2, input voltage terminal 120a_3, and switching terminal SWa. In the example of FIG. 4, power stage circuit 120a also has inputs 120a_4 and 120a_5. Input 120a_4 is coupled to the output voltage terminal 150 of TLVR 100 and accordingly receives the output voltage Vout. An external resistor Rset (e.g., external to the IC containing power stage circuit 120a) can be coupled to input 120a_5, which may also be called the Lset input. Resistor Rset has a resistance that is proportional to the inductance of inductor L1 and is used to configure, as described below, the emulation circuit within the power stage to have a value indicative of the inductance of inductor L1.

Power stage circuit 120a in the example of FIG. 4 includes an analog-to-digital converter (ADC) 408 and a current source 409. Current source 409 applies a fixed current to resistor Rset, and ADC 408 converts the resulting analog voltage across resistor Rset to a digital value Rsct<n:0>, where n is an integer (e.g., 7). Because the resistance of resistor Rset is proportional to the inductance of inductor L1, digital value Rset<n:0> represents the inductance of inductor L1. In the example of FIG. 4, power stage circuit 120a receives the input voltage Vin (through input voltage terminal 120a_3), the output voltage Vout (through input 120a_4), and a value indicative of the inductance of inductor L1 (through input 120a_5). Emulation circuit 130a within power sage 120a uses those values/signals to emulate the inductor current I_L1 during the on-time and blanking period.

FIG. 5 is a schematic diagram of power stage circuit 120a in an example which lacks the inputs 120a_4 and 120a_5 of FIG. 4. Resistor Rset also is not included in this example. Because the power stage circuit 120a in the example of FIG. 5 lacks inputs corresponding to inputs 120a_4 and 120a_5 the resulting footprint (area) for the IC containing the power stage circuit 120a of FIG. 5 may be smaller than the corresponding footprint of the IC containing the power stage circuit 120a of FIG. 4. Lacking inputs to receive output voltage Vout and to be coupled to a resistor Rset, power stage circuit 120a in the example of FIG. 5 employs alternative techniques, described below, to determine output voltage Vout and a value indicative of the inductance of inductor L1.

FIG. 6 is a schematic diagram of the emulation circuit 130, in an example. Emulation circuit 130 includes switches SW1 and SW2 (e.g., transistors), a resistor R2, integrator 140, and emulation control circuit 142. Emulation control circuit 142 includes an integration logic circuit 610, current source circuits 620 and 630, and a capacitor C2. Integrator 140 includes a transconductance amplifier 604 and a capacitor C3. Integration logic circuit 610 includes a comparator 611, flip-flops 612 and 613 (e.g., D flip-flops), counters 614 and 615 (e.g., up/down counters), and logic circuit 616. Control logic 616 may include logic gates, flip-flops, registers, etc.

Switch SW1 is coupled in series with resistor R2 between the positive and negative inputs of integrator 140. One terminal of capacitor C3 is coupled to the output of transconductance amplifier 604 and to a positive input of comparator 611. The other terminal of capacitor C3 is coupled to the negative input of comparator 611 and receives a reference voltage REF, e.g., from a reference voltage circuit. Switch SW2 is coupled across capacitor C3 and to the integrator's output 604a. The output of comparator 611 is coupled to the data (D) inputs of flip-flops 612 and 613. Control logic 616 has outputs 616a, 616b, 616c, 616d, and 616e and has an input 616i. Output 616a is coupled to the clock inputs of flip-flop 613 and counter 615. Output 616b is coupled to the clock inputs of flip-flop 612 and counter 614. Outputs 616c and 616d are coupled to control inputs of switches SW2 and SW1, respectively. Output 616e is coupled to the selection input 659 of analog multiplexer 180. Selection input 659 corresponds to, for example, selection inputs 180a_1 of analog multiplexer 180a or the selection inputs of analog multiplexers 180b and 180c in FIG. 1. Input 616i receives the PWM signal which is used by control logic 616 to generate its output signals.

In one example, counters 614 and 615 are up/down counters which can increment or decrement their output count value based on the logic state (0 or 1) at corresponding control inputs 614a and 615a upon occurrence of a clock edge (e.g., a rising edge) of a signal at their respective clock inputs. The Q outputs of flip-flops 612 and 613 are coupled to control inputs 614a and 615a of counters 614 and 615, respectively. In one example, the output count value from counter 614 is an eight-bit count value VC1<7:0> and the output count value from counter 615 also is an eight-bit count value VC2<7:0>. In other examples, counters 614 and 615 may produce output count values having a number of bits other than eight.

Current source circuit 620 includes an operational amplifier (OP AMP) 621, a current mirror 622, a transistor M1, a switch 625 (e.g., a transistor), and a configurable resistor R3. Current mirror 622 includes transistors M2 and M3. In this example, transistor M1 is an n-channel field effect transistor (NFET), and transistors M2 and M3 are p-channel field effect transistors (PFETs). The positive input of OP AMP 621 receives a voltage proportional to the input voltage Vin (K*Vin, where K is a fixed value). In one example, the voltage K*Vin may be the output signal from a voltage divider having voltage Vin as an input. The output of OP AMP 621 is coupled to the gate of transistor M1. The source of transistor M1 is coupled to a terminal of resistor R3 and to the negative input of OP AMP 621. The other terminal of resistor R3 is coupled to ground. OP AMP 621 has an offset input 621a. The output 614b of counter 614 is coupled to the offset input 621a of OP AMP 621 and provides the count value VC1<7:0> to the OP AMP's offset input 621a to thereby adjust the offset voltage of OP AMP 621. The resistance of configurable resistor R3 is set based on the digital value Rsct<n:0> (e.g., as shown in FIG. 4). In one example, configurable resistor R3 includes multiple resistors coupled in parallel or in series and to switches controlled by the bits of digital value Rset<n:0>.

Current source circuit 630 includes an OP AMP 623, a transistor M4 (e.g., an NFET), and a configurable resistor R4. Configurable resistor R4 may be constructed similar to configurable resistor R3. The resistance of configurable resistor R4 is also set based on the digital value Rset<n:0>. The positive input of OP AMP 623 receives a voltage proportional to Vout (K*Vout), where K for K*Vout may the same or different value as K for K*Vin). In the example of FIG. 4, the output voltage Vout is provided to input 120a_4 of power stage circuit 120a. In an example power stage circuit 120a that lacks an input to receive Vout (e.g., power stage circuit 120a of FIG. 5), the power stage circuit determines Vout through an alternative technique, shown and described below with respect to FIG. 10. The output of OP AMP 623 is coupled to the gate of transistor M4. The source of transistor M4 is coupled to a terminal of resistor R4 and to the negative input of OP AMP 623. The other terminal of configurable resistor R4 is coupled to ground. OP AMP 623 also has an offset input 623a, which is coupled to the output 615b of counter 615 and receives count value VC2<7:0> from counter 615. The resistance of resistor R4 is set based on the value of count value VC2<7:0>.

A terminal of capacitor C2 is coupled to the drains of transistors M2 (via the switch 625) and M4. Another terminal of capacitor C2 is coupled to a ground terminal. OP AMP 621 is configured as a unity gain buffer with an adjustable offset voltage. The voltage K*Vin at its positive input, as adjusted based on count value VC1<7:0> applied to offset input 621a, is applied across resistor R3, which then controls the current I_R3 through resistor R3 and transistor M1. Current I_R3 is mirrored (e.g., a 1:1 current mirror ratio) by current mirror 622 as current I_M2. Similarly, OP AMP 623 is configured as a unity gain buffer, which applies a voltage across resistor R4 approximately equal to voltage K*Vout applied to the positive input of OP AMP 623, as adjusted based on count value VC2<7:0> applied to offset input 623a.

Current I_M2, which is the current through transistor M2, is proportional to the ratio of the input voltage Vin to the resistance of resistor R3, and the resistance of resistor R3 is based on the value of RSET<n:0>, and the value of RSET<n:0> is based on the inductance of the respective inductor L1-L3. Accordingly, current I_M2 is proportional to Vin/L, where L represents the inductance of the respective inductor L1-L3 of the power stage circuit 120. Current I_R4, which is the current through resistor R4, is proportional to the ratio of the output voltage Vout to the resistance of resistor R4, and the resistance of resistor R4 is based on the value of RSET<n:0>, which is based on the inductance of the respective inductor L1-L3. Accordingly, current I_R4 is proportional to Vout/L.

Current I_C2 is the current to capacitor C2. Current I_C2 is given by:

$$I\_C2 = I\_M2 - I\_R4 \qquad ( Eq . 4 )$$

Current I_C2 is proportional to (Vin−Vout)/L. During the Ton time period signal PWM is logic high thereby closing switch 625. With switch 625 closed, applying a fixed current to capacitor C2 causes the capacitor's voltage, which is signal EMUL_CURR, to increase based on the magnitude of the fixed current, which is proportional to (Vin−Vout)/L. Accordingly, the signal EMUL_CURR is a voltage that increases based on (Vin−Vout)/(L*C2). Per Eq. 2 above, the current through inductor L increases based on

$$\frac{Vin - Vout}{L 1} .$$

During the Toff time period, the current source circuit 620 is turned off thereby causing the voltage across capacitor C2 to have a voltage proportional to −Vout/L. In one example, current source circuit 620 is turned off by signal PWM opening (turning off) switch 625. For example, when signal PWM is logic low, switch 625 is opened thereby turning off current I_M2.

Current sense signal SENSE from the respective current sense circuit 128 is provided to the positive input of integrator 140. Signal EMUL_CURR is provided to the negative input of integrator 140. Integrator 140 integrates the difference between signals SENSE and EMUL_CURR over a period of time thereby resulting in a signal INT at the output of the integrator that is approximately equal to the average of signal SENSE. As described below, the integrated difference between signals SENSE and EMUL_CURR is compared to a threshold to determine whether the integrated difference is relatively low. If the integrated difference is not relatively low, the currents I_R3 and I_R4 produced by current source circuits 620 and 630, respectively, are iteratively adjusted over one or more PWM switching cycles until the integrated difference is relatively low. In one example, integrator 140 integrates the difference between signals SENSE and EMUL_CURR over a single time window during each switching cycle.

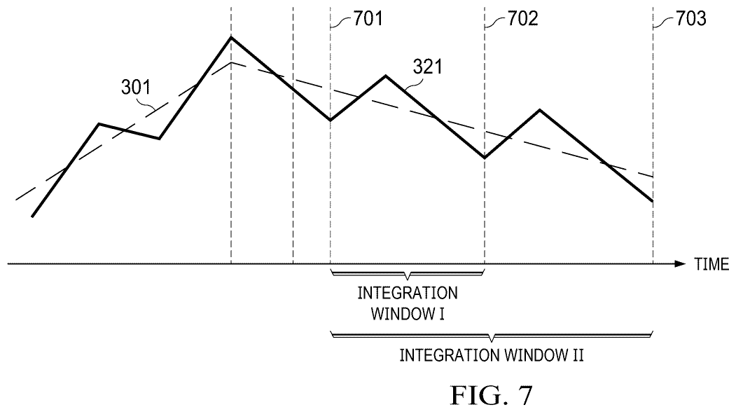

Using a single time window over which the difference between signals SENSE and EMUL_CURR is integrated can result in multiple different signals EMUL_CURR, some of which may not be equal to the average of the actual inductor current (signal SENSE). To improve the accuracy of the signal EMUL_CURR to approximately match the average of the inductor current generated by a given power stage, integrator 140 integrates the difference between signals SENSE and EMUL_CURR over multiple time windows during each switching cycle, as described below. For example, FIG. 7 is a graph of waveforms 301 and 321 from FIG. 3 illustrating two time windows—Integration Window I and Integration Window II. In this example, both time windows start at the same time point, e.g., time point 701. Integration Window I ends at time point 702, and Integration Window II ends at a later time point, time point 703. In other examples, Integration Windows I and II start at different time points.

Referring again to FIG. 6, signal INT from integrator 140 is the integrated difference between signals SENSE and EMUL_CURR. Signal INT is compared to reference voltage REF by comparator 611 to determine whether the integrated difference between signals SENSE and EMUL_CURR is relatively low (e.g., approximately equal to reference voltage REF). When the integrated difference between signals SENSE and EMUL_CURR is relatively low, then the signal EMUL_CURR is approximately equal to the average of signal SENSE waveform. With signal INT from integrator 140 provided to the positive input of comparator 611 and reference voltage REF provided to the negative input, the output signal from comparator 611 being logic 1 indicates that the integrated difference is not below the threshold set by the reference voltage REF. The output signal from comparator 611 being logic 0 indicates that the integrated difference is below the threshold set by the reference voltage REF. In other examples, the signal SENSE and the reference voltage REF can be provided to the negative and positive inputs, respectively, of comparator 611, and the polarity of the comparator's output signal will be the opposite from that described above.

Control logic 616, in the example of FIG. 6, implements two integration time windows. Control logic 616 generates signal VC1_SAMPLE at its output 616b to the clock inputs of flip-flop 612 and counter 614. Control logic 616 generates signal VC2_SAMPLE at its output 616a to the clock inputs of flip-flop 613 and counter 615. Control logic 616 causes signal VC1_SAMPLE to have a rising edge before a corresponding rising edge of signal VC2_SAMPLE. In one example, control logic 616 causes signal VC1_SAMPLE to have a rising edge at time point 702 (FIG. 7) and signal VC2_SAMPLE to have a rising edge at time point 703. In one example, control logic 616 asserts signal VC1_SAMPLE to a logic high level following a delay after the PWM signal becomes logic low. The delay (e.g., 225 ns) ensures that the blanking period 314 has ended. Then, after asserting VC1_SAMPLE logic high, control logic 616 waits for another delay period (e.g., 25 ns) before asserting VC2_SAMPLE logic high. Each flip-flop 612 and 613 samples the output signal of comparator 611 upon occurrence of a rising edge on the respective clock input of the flip-flop thereby forcing the Q output of the flip-flop to have the same logic level as the output signal from comparator 611.

If the signal from the Q output of flip-flop 612 is, for example, a logic 1, counter 614 will increment its output count value VC1<7:0> upon occurrence of a rising edge of signal VC1_SAMPLE, and if the signal form the Q output of flip-flop 612 is a logic 0, counter 614 will decrement its output count value VC1<7:0> upon occurrence of a rising edge of signal VC1_SAMPLE. Similarly, if the signal from the Q output of flip-flop 613 is, for example, a logic 1, counter 615 will increment its output count value VC2<7:0> upon occurrence of a rising edge of signal VC2_SAMPLE, and if the signal form the Q output of flip-flop 613 is a logic 0, counter 615 will decrement its output count value VC2<7:0> upon occurrence of a rising edge of signal VC2_SAMPLE. As described above, the output count values VC1<7:0> and VC2<7:0> indirectly control the currents I_M2 and I_R4 that control the rate at which capacitor C2 is charged and discharged.

Control logic 616 asserts signal RESET1 (e.g., logic high) at its output 616c after each switching cycle to cause switch SW2 to close to thereby resetting integrator 140. Control logic 616 asserts signal RESET2 (e.g., logic high) at its output 616d after the blanking period 314 (FIG. 2) to thereby close switch SW1. With switch SW1 closed, signal EMUL_CURR is forced to be close to signal SENSE thereby allowing capacitor C2 to be quickly charged to approximately the level of signal SENSE as the next iteration of the integration and signal emulation begins.

Control logic 616 also asserts selection signal SELECTION at its output 616e to a logic state to thereby cause analog multiplexer 180 to select either the current sense signal SENSE as the output signal IMON or signal EMUL_CURR as the output signal IMON. Control logic 616 generates selection signal SELECTION to have a logic state (e.g., logic high) to cause analog multiplexer 180 to select signal SENSE as its output signal IMON during the off-time Toff following the blanking period 314. Control logic 616 generates selection signal SELECTION to have the opposite logic state (e.g., logic low) to cause analog multiplexer 180 to select signal EMUL_CURR as its output signal IMON during the on-time Ton and blanking period 314.

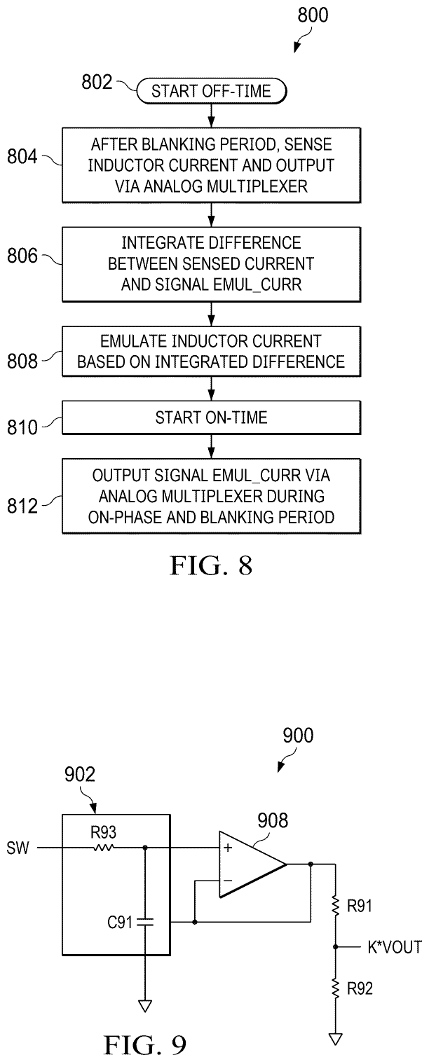

FIG. 8 is a flow diagram 800 illustrating the operation of a power stage circuit 120, in an example. At operation 802, the power stage circuit 120 starts the off-time of a given cycle. The off-time is started by turning off the high side switch SW_H and turning on the low side switch SW_L. At operation 804, after the blanking period 314, the current of the associated primary inductor (e.g., L1, L2, L3) is sensed, for example, by current sense circuit 128, and the current sense signal SENSE is output via analog multiplexer 180 as signal IMON. At operation 806, integrator 140 integrates the difference between signal SENSE and emulated signal EMUL_CURR over one or two time windows as described above. At operation 808, emulation control circuit 142 emulates the inductor's current, e.g., by adjusting the charge and/or discharge current of capacitor C2, based on the integrated difference between signal SENSE and signal EMUL_CURR, as described above. At operation 810, the power stage circuit 120 starts the on-time Ton, e.g., by turning off the low side switch SW_L and turning on the high side switch SW_H. At operation 812, during the on-time Ton and blanking period 314, control logic 616 causes analog multiplexer 180 to output the emulated signal EMUL_CURR as the output signal IMON.

In the example of power stage circuit 120 in FIG. 5, the power stage circuit lacks an input to receive the output voltage VOUT. However, an input (e.g., positive input) of OP AMP 623 (FIG. 6) receives a voltage proportional to the output voltage VOUT. FIG. 9 is a schematic diagram of a circuit 900 that generates a voltage proportional to VOUT to be provided to the input of OP AMP 623. The voltage of the switching terminal SW (e.g., switching terminal SWa in FIG. 5) is provided as an input to circuit 900, and the circuit 900 generates an output voltage K*VOUT based on the switching terminal voltage. For a buck converter, the voltage of the switching terminal toggles between VIN and ground in accordance with the duty cycle of the converter such that the average of the switching signal is equal to VOUT.

Circuit 900 includes a low-pass filter circuit 902, an OP AMP 908, and resistors R91 and R92. In the example of FIG. 9, low-pass filter circuit 902 includes a resistor R93 and a capacitor C91. One terminal of resistor R93 receives the voltage from the switching terminal and the other terminal of resistor R93 is coupled to a terminal of capacitor C91 and to the positive input of OP AMP 908. The other terminal of capacitor C91 is coupled to ground. The voltage from low-pass filter circuit 902 to the positive input of OP AMP 908 is a direct current (DC) voltage approximately equal to the output voltage VOUT. The output of OP AMP 908 is coupled to the negative input of OP AMP 908 thereby configuring OP AMP 908 as a unity gain buffer. Resistors R91 and R92 are coupled in series between the output of OP AMP 908 and ground and function as a voltage divider of the output voltage of OP AMP 908. In the example of FIG. 9, the value of K is R92/(R91+R92). Low-pass filter circuit 902 low-pass filters the voltage of the switching terminal, and OP AMP 908 buffers the output voltage from low-pass filter circuit 902. The voltage divider formed by resistors R91 and R92 scales down the output voltage from OP AMP 908 to produce the voltage K*VOUT.

In an example of a power stage circuit 120 described above (e.g., power stage circuit 120a in FIG. 5), the power stage IC also lacks an input to be coupled to resistor Rset and thereby lacks the ability to be informed as to the inductance of the power stage's inductor (e.g., inductor L1 for power stage circuit 120a). However, the current source circuits 620 and 630 include configurable resistors R3 and R4, respectively, which are configured based on the inductance of the power stage's inductor. FIG. 10 is a schematic diagram of an emulation circuit 130 in an example by which the emulation circuit determines the value RSET<n:0>.

FIG. 10 includes another example of emulation circuit 130, identified in FIG. 10 as emulation circuit 1000. In the example of FIG. 10, emulation circuit 1000 has many of the same components coupled together in the same or similar manner as for emulation circuit 130 in the example of FIG. 6, and such components and their connections are not repeated here. Emulation circuit 1000 in FIG. 10 includes a selection circuit 1010 that is not present in the example of FIG. 5. Emulation circuit 1000 in FIG. 10 also includes a demultiplexer 1024 that is not present in the example of FIG. 5.

Selection circuit 1010 includes switches SW3, SW4, SW5, and SW6. A terminal of switch SW3 is coupled to the positive input of integrator 140 and another terminal of switch SW3 is coupled to the positive input of comparator 611. Similarly, a terminal of switch SW6 is coupled to the negative input of integrator 140 and another terminal of switch SW6 is coupled the negative input of comparator 611. A terminal of switch SW4 is coupled to the output of integrator 140 and another terminal of switch SW4 is coupled to the positive input of comparator 611. A terminal of switch SW5 is coupled to the reference voltage VREF and another terminal of switch SW5 is coupled to the negative input of comparator 611. Each switch SW3-SW6 has a control input coupled to an output of control logic 616. Control logic 616 in FIG. 10 is similar to control logic 616 in FIG. 6. In addition to outputs 616a-616e described above regarding FIG. 6, control logic 616 in FIG. 10 also includes outputs 616f, 616g, and 616h. Output 616f is coupled to the control inputs of switches SW3 and SW6 and provides signal A to the control inputs of switches SW3 and SW6. Output 616g is coupled to the control inputs of switches SW4 and SW5 and provides signal B to the control inputs of switches SW4 and SW5. Accordingly, control logic 616 can control which of switches SW3-SW6 are on and which of switches SW3-SW6 are off.

Demultiplexer 1024 has an input 1024a, a selection input 1024b, and outputs 1024c and 1024d. Input 1024a, selection input 1024b, and outputs 1024c and 1024d arc each multi-bit inputs/outputs. Output 614b of counter 614 is coupled to input 1024a of demultiplexer 1024. Output 1024c is coupled to offset input 621a of OP AMP 621. Output 1024d of demultiplexer 1024 is coupled to configurable resistors R3 and R4 and provides the digital value RSET<n:0> to configure the resistance of resistors R3 and R4.

Upon, for example, initialization/power-up reset of emulation circuit 130, control logic 616 asserts signals A and B to logic states such that switches SW3 and SW6 are closed and switches SW4 and SW5 are open. In this state, comparator 611 compares signal SENSE to signal EMUL_CURR. Control logic 616 also asserts signal VC2_SAMPLE to a logic state (e.g., logic 0) to prevent counter 615 from changing its count value VC2<7:0>. Further, control logic 616 also asserts signal FREEZE_LSET at its output 616h to a logic state (e.g., logic 0) to cause demultiplexer 1024 to provides its input signal VC1<7:0> to its output 1024d. Current I_R3 in current source circuit 620 is adjusted with each switching cycle during initialization of emulation circuit 130 based on the comparison of signal SENSE to signal EMUL_CURR. The output signal from comparator 611 is latched into flip-flop 612 upon each rising edge of signal VC1_SAMPLE generated by control logic 616. The output signal from flip-flop 612 is then used to cause counter 614 to increment or decrement its count value VC1<7:0> based on the latched comparator value from flip-flop 612. Demultiplexer 1024 then provides the count value VC1<7:0> to configurable resistors R3 and R4 to cause the configurable resistors to adjust their resistances as described above.

After one or more switching cycles, the signal EMUL_CURR will approximately match the signal SENSE. At that point, control logic 616 discontinues the calibration process through which the value of RSET<n: 0> is determined by asserting signals A, B, and FREEZE_LSET to logic states such that switches SW3 and SW6 are open, switches SW4 and SW5 are closed, demultiplexer 1024 is configured to provide its input signal through to its output 1024c.

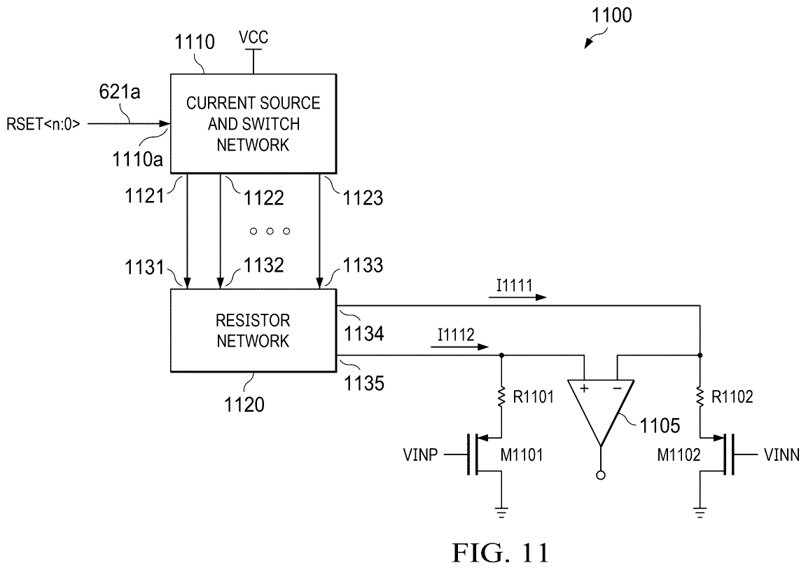

As described above, OP AMPs 621 and 623 have offset inputs 621a and 623a, respectively. FIG. 11 is a schematic diagram of at least a portion of an OP AMP 1100, which can be used to implement OP AMP 621 and/or 623. OP AMP 1100 includes an input stage including transistors M1101 and M1102, resistors R1101 and R1102, a current source and switch network 1110, and a resistor network 1120. Transistors M1101 and M1102 are PFETs in this example, but can be other types of transistors (e.g., NFETs) in other examples. Resistor R1101 is coupled between the source of transistor M1101 and an output 1135 of resistor network 1120. Similarly, resistor R1102 is coupled between the source of transistor M1102 and an output 1135 of resistor network 1120. The drains of transistors M1101 and M1102 are coupled to ground. A supply voltage VCC is provided to the current source and switch network 1110. Current source and switch network 1110 includes an input 1101a and outputs 1121, 1122, and 1123. Digital value RSET<n: 0> is provided to input 1110a. In some examples, the number of outputs 1121-1123 of switch network 1110 matches the number of bits of digital value Rset<n: 0>. Current source and switch network 1110 controls the current through outputs 1121-1123 based on the bits of digital value Rset<n: 0>. Outputs 1121-1123 of switch network 1110 couple to respective inputs 1131-1133 of resistor network 1120. Resistor network 1120 includes multiple resistors. The currents into its inputs 1131-1133 results in currents I1111 and I1112 through the respective resistors R1101 and R1102. Current I1111 may be the same or different than current I1112. The currents I1111 and I1112 are controlled by the digital value Rsct<n: 0>. The gates of transistors M1101 and M1102 are coupled to the positive and negative inputs of OP AMP 1100. Currents I1111 and I1112 through the respective resistors R1101 and R1102 adjust the offset voltage for the OP AMP 1100. Accordingly, the offset voltage is controlled by the digital value Rsct<n: 0>.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. An apparatus, comprising:
a first switch having a terminal;
a second switch having a terminal coupled to the terminal of the first switch at a switching terminal;
a sense circuit having an input terminal and an output terminal, the input terminal of the sense circuit coupled to the terminal of the first switch and to the terminal of the second switch; and
an integrator having a first input terminal coupled to the output terminal of the sense circuit and having a second input terminal.

2. The apparatus of claim 1, further including a capacitor coupled to the second input terminal, and wherein the integrator is configured to integrate a difference over a time window between a signal at the first input and a voltage from the capacitor.

3. The apparatus of claim 2, wherein the integrator is configured to integrate a difference between a voltage at the first input and a voltage from the capacitor over a first time window and over a second time window, the second time window partially overlapping the first time window.

4. The apparatus of claim 2, further comprising:
a first current source circuit having an output terminal; and
a second current source circuit having an output terminal; and
the capacitor coupled to the output terminals of the first and second current source circuits.

5. The apparatus of claim 4, wherein the second current source circuit includes an input terminal, and the apparatus includes a low-pass filter circuit having an input terminal coupled to the switching terminal and having an output terminal coupled to the input terminal of the second current source circuit.

6. The apparatus of claim 1, further comprising:
a third switch having a control input terminal;
a resistor coupled in series with the third switch, the third switch and resistor coupled between the first and second input terminals of the integrator; and
control logic having an output terminal coupled to the control input terminal of the third switch.

7. The apparatus of claim 1, wherein the integrator has an output, and the apparatus further comprises:
a comparator having a first input terminal and a second input terminal;
a third switch coupled between the first input terminal of the integrator and the first input terminal of the comparator;
a fourth switch coupled between the output terminal of the integrator and the first input terminal of the comparator;
a fifth switch coupled between a reference voltage circuit and the second input terminal of the comparator; and
a sixth switch coupled between the second input terminal of the integrator and the second input terminal of the comparator.

8. The apparatus of claim 7, wherein the comparator has an output terminal, and the apparatus further comprises:
a first flip-flop having an input terminal coupled to the output terminal of the comparator, the first flip-flop having an output terminal;
a second flip-flop having an input terminal coupled to the output terminal of the comparator, the second flip-flop having an output terminal;
a first counter having an input terminal coupled to the output terminal of the first flip-flop;
a second counter having an output terminal coupled to the output terminal of the second flip-flop;
a first current source circuit having an input terminal coupled to the output terminal of the first counter and having an output terminal;
a second current source circuit having an input terminal coupled to the output terminal of the second counter and having an output terminal; and
a capacitor coupled to the output terminals of the first and second current source circuits.

9. An apparatus, comprising:
a capacitor having a terminal;
a first current source circuit having an output terminal coupled to the terminal of the capacitor;
a second current source circuit having an output terminal coupled to the terminal of the capacitor; and
an integrator having a first input terminal and having a second input terminal, the second input terminal coupled to the terminal of the capacitor, the integrator configured to integrate a difference between a voltage at the first input and a voltage at the second input over a first time window and over a second time window, the second time window partially overlapping the first time window.

10. The apparatus of claim 9, wherein the second current source circuit includes an input terminal, and the apparatus includes a low-pass filter circuit having an input terminal coupled to a switching terminal and having an output terminal coupled to the input terminal of the second current source circuit.

11. The apparatus of claim 9, further comprising:
a third switch having a control input terminal;
a resistor coupled in series with the third switch between the first and second input terminals of the integrator; and
control logic having an output terminal coupled to the control input terminal of the third switch.

12. The apparatus of claim 9, wherein the integrator has an output terminal, and the apparatus includes a comparator having a first input terminal coupled to the output terminal of the integrator and having a second input terminal coupled to a reference voltage circuit.

13. The apparatus of claim 12, wherein the first current source circuit has an input terminal, the second current source circuit has an input terminal, the comparator has an output terminal, and the apparatus further includes:
a first counter having an input terminal coupled to the output terminal of the comparator and having an output terminal coupled to the input terminal of the first current source circuit; and
a second counter having an input terminal coupled to the output terminal of the comparator and having an output terminal coupled to the input terminal of the second current source circuit.

14. The apparatus of claim 9, wherein the integrator has an output terminal, and the apparatus includes:
a comparator having a first input terminal and a second input terminal;
a third switch coupled between the first input terminal of the integrator and the first input terminal of the comparator;
a fourth switch coupled between the output terminal of the integrator and the first input terminal of the comparator;
a fifth switch coupled between a reference voltage circuit and the second input terminal of the comparator; and
a sixth switch coupled between the second input terminal of the integrator and the second input terminal of the comparator.

15. A power converter, comprising:
a controller having a first output terminal, a second output terminal, first input terminal, and a second input terminal;
a first power stage circuit having an input terminal, a first output terminal, and a second output terminal, the input terminal coupled to the first output terminal of the controller, the first output terminal coupled to the first input terminal of the controller, the first power stage circuit including a first integrator configured to integrate a difference between a first signal and a second signal;
a second power stage circuit having an input terminal, a first output terminal, and a second output terminal, the input terminal coupled to the second output of the controller, the first output terminal coupled to the second input terminal of the controller, the second power stage circuit including a second integrator configured to integrate a difference between a third signal and a fourth signal;
a first inductor having a first terminal and a second terminal, the first terminal coupled to the second output terminal of the first power stage circuit; and
a second inductor having a first terminal and a second terminal, the first terminal coupled to the second output terminal of the second power stage circuit and the second terminal coupled to the second terminal of the first inductor.

16. The power converter of claim 15, wherein each of the first and second integrators is configured to integrate the respective difference over a first time window and over a second time window, the second time window partially overlapping the first time window.

17. The power converter of claim 15, wherein each of the first and second integrators has an output terminal, and each of the first and second power stage circuit further includes:
a comparator having a first input terminal coupled to the output terminal of the respective integrator, having an input terminal coupled to a reference voltage circuit, and having an output terminal;
a first counter having an input terminal coupled to the output terminal of the respective comparator and having an output terminal;
a second counter having an input terminal coupled to the output terminal of the respective comparator and having an output terminal;
a first current source circuit having an input terminal coupled to the output terminal of the respective first counter and having an output terminal;
a second current source circuit having an input terminal coupled to the output terminal of the respective first counter and having an output terminal; and
a capacitor having a terminal coupled to the output terminals of the respective first and second current source circuits and to an input terminal of the respective integrator.

18. The power converter of claim 17, wherein:
the input terminal of the second current source circuit of each of the first and second power stage circuits is a first input terminal;
the second current source circuit of each of the first and second power stage circuits has a second input terminal; and
each of the first and second power stage circuits includes a low-pass filter having an input terminal coupled to the second output terminal of the respective power stage circuit and having an output terminal coupled to the second input terminal of the respective second current source circuit.

19. The power converter of claim 15, wherein each of the first and second integrators includes a first input terminal and a second input terminal, and wherein each of the first and second power stage circuits includes:
a switch having a control input terminal;
a resistor coupled in series with the switch between the first and second input terminals of the respective integrator; and
control logic having an output terminal coupled to the control input terminal of the switch.

20. The power converter of claim 15, further including:
a third inductor inductively-coupled to the first inductor; and
a fourth inductor inductively-coupled to the second inductor, the fourth inductor coupled to the third inductor.
